(19) United States
(12) Patent Application Publication
(10) Pub. No.: US 2002/0185554 A1
(43) Pub. Date: Dec. 12, 2002

(54) Method for treating a gas dispensing device and device treated

(75) Inventors: Kuo-Feng Lu, Hsin-chu (TW); Shun-Chin Sung, Taipei (TW); Tsu-Kuang Hou, Taichung (TW); Wen-Chin Ho, Hsinchu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 09/876,435

(22) Filed: Jun. 7, 2001

(51) Int. Cl. B05B 1/14

(52) U.S. Cl. 239/548; 239/558

(57) ABSTRACT

A method for treating a gas dispensing device used in chemical vapor deposition and the device treated by such method are disclosed. In the method, a gas dispensing device fabricated substantially of aluminum is first provided that has a planar surface with a multiplicity of apertures therethrough. The planar surface is then exposed to a diluted acid solution that contains at least HNO₃ for conducting a cleaning process. After the residual diluted acid solution has been removed from the planar surface, a second step of oxidation is carried out on the surface of the gas dispensing device by exposing the planar surface to an acid solution that contains at least HNO₃ for a sufficient length of time until a metal oxide layer such as Al₂O₃ is formed to a thickness of at least 1 μm on the planar surface.

### FIELD OF THE INVENTION

The present invention generally relates to a method for treating a gas dispensing device used in chemical vapor deposition and device treated and more particularly, relates to a method for treating a gas dispensing device used in chemical vapor deposition by a dual-step cleaning/oxidation process for growing a thin layer of Al₂O₃ on a surface of the dispensing device and the device treated by such method.

### BACKGROUND OF THE INVENTION

Chemical vapor deposition (CVD) technique has been broadly used in depositing semiconductor materials in the semiconductor fabrication technology. For instance, various layers of dielectric materials including those of silicon oxide can be deposited by the CVD technique. Since chemical vapor deposition is a process in which a film can be deposited by a chemical reaction or decomposition of a gas mixture at elevated temperatures on a wafer surface, typical CVD deposited films include single crystal silicon, polycrystalline silicon, silicon oxide, silicon nitride, phosphosilicate glass, borosilicate glass, borophosphosilicate glass, metals and metal compounds.

Chemical vapor deposition can be performed by various techniques including, but not limited to, high density plasma CVD, plasma enhanced CVD and sub-ambient CVD. The high density plasma CVD and the plasma enhanced CVD techniques utilized plasma ions to enhance the deposition rate and to reduce the deposition temperature for achieving obvious processing advantages. For instance, while silicon oxide can be deposited by a traditional CVD method at a temperature of 400° C. or higher, the deposition temperature can be considerably reduced by the plasma enhanced CVD or high density plasma CVD techniques.

In a chemical vapor deposition chamber that is used for depositing silicon oxide, it is inevitable that silicon oxide particles or films are also deposited on the chamber interior away from the wafer surface. After repeated deposition processes are conducted in the chamber, residual oxide deposited on the chamber interior becomes a serious source of wafer contamination. Larger particles or thicker films of oxide tend to peel off from the chamber interior under high vacuum during the deposition process and fall onto the wafer surface. It is therefore necessary, as a preventive maintenance procedure, to clean the chamber interior after a pre-determined number of wafers have been processed in the chamber. One of the more advanced cleaning methods for the chamber interior is in-situ plasma cleaning such as by fluorine-containing etchant gas.

In the cleaning process for a chemical vapor deposition chamber by plasma ions of a fluorine-containing etchant, it is desirable that the endpoint of the cleaning process can be readily identified such that either under-cleaning or over-cleaning can be avoided. When the chamber interior is under-cleaned, particles or films left over may still present a contamination problem to the subsequent deposition process conducted in the chamber. When the chamber interior is over-cleaned, the corrosive etchant may damage the chamber interior and thus cause metal particle contamination. The ability to detect the endpoint of a chamber interior cleaning process is therefore an important requirement of the cleaning technique.

In a conventional cleaning process for plasma enhanced CVD or sub-ambient CVD, radio frequency is used as an energy source for generating plasma gas inside the chamber body, i.e. the plasma is generated in-situ. When the cleaning process is approaching an end, changes in the plasma radiation brightness can be readily used as an index of endpoint. However, in a high density plasma CVD chamber, microwave is used as the energy source for producing plasma ions outside the chamber body, i.e. plasma ions are produced ex-situ. When the cleaning process is approaching an end, any change in the plasma radiation brightness is barely detectable and thus, presenting great difficulties in identifying an endpoint of the cleaning process. As a result, when a high density plasma CVD chamber is cleaned, the cleaning process is normally time-controlled by a trial and error technique. The time-controlled cleaning method (i.e. or time mode) used conventionally is inadequate since it frequently results in over-cleaning of the deposition chamber and thus, damaging the chamber interior.

Another problem in the cleaning of a chemical vapor deposition chamber by plasma ions of flourine is the excessive wear caused on components that are fabricated of aluminum. One of such components is a gas dispensing unit, or commonly known as a shower head. This is shown in a conventional setup of a chemical vapor deposition chamber 10 in FIG. 1.

A gas dispensing unit 12 is suspended on the top ceiling of the CVD apparatus 10. Also shown in FIG. 1 are the other essential components of the CVD chamber 10 such as a susceptor 14 for holding a wafer 16 on top equipped with wafer lift fingers 18. The reactant gases and radio frequency are fed into the gas dispensing unit 12 through conduit 20. The chamber cavity 22 is heated through a quartz window 24 by a plurality of heating lamps 26 situated in a lamp module 28.

An enlarged, perspective view of the gas dispensing unit 12, i.e. the shower head, is shown in FIG. 2. The gas dispensing units 12 is generally provided with a planar surface 30 equipped with a multiplicity of apertures 32 therethrough for the passage of the reactant gases. The gas dispensing unit 12 is further provided with a mixing chamber (not shown) situated behind the planar surface 30 adapted to receive flows of at least two reactant gases flown in through conduit 20 for mixing and for dispensing through the multiplicity of apertures 32 into the reaction chamber 22 (FIG. 1). Of the numerous chamber components in the CVD apparatus 10, the planar surface 30 of the gas dispensing unit 12 is one of the most difficult to clean. Since the gas dispensing unit 12 is normally fabricated of aluminum, the planar surface 30 of the gas dispensing unit 12 can be easily attacked by the plasma ions of flourine used in a plasma gas cleaning process. If the cleaning time is shortened in order to protect the planar surface 30 from being over-cleaned, or over-etched, the deposition byproducts attached to the planar surface 30 cannot be thoroughly cleaned and thus, act as a contamination source in the CVD chamber 10. It is therefore desirable to have a method that not only cleans the planar surface 30 of the gas dispensing unit 12, but also to treats the surface such that it cannot be easily attacked by the plasma ions of flourine carried out during a preventive maintenance procedure.

When the conventional gas dispensing unit is used in a chemical vapor deposition process, the thickness uniformity of deposition, i.e. in the case of a deposition of silicon oxide on a wafer, is sometimes poor. For instance, as shown in FIG. 4, for a target thickness of 4000 Å of SiO₂, a thickness variation between a low 3700 Å and a high 4300 Å is observed. The thickness uniformity obtained by using the conventional gas dispensing device is therefore not acceptable. A particle contamination problem is also observed when the conventional gas dispensing unit is utilized. This is shown in the left side of the graphs shown in FIGS. 6 and 7. FIG. 6 illustrates the total particle count, while FIG. 7 illustrates large particle count.

It is therefore an object of the present invention to provide a method for treating a gas dispensing unit used in chemical vapor deposition that does not have the drawbacks or shortcomings of the conventional treatment methods.

It is another object of the present invention to provide a method for treating a gas dispensing unit used in chemical vapor deposition by a dual-step cleaning/oxidation technique.

It is a further object of the present invention to provide a method for treating a gas dispensing unit used in chemical vapor deposition by first cleaning the device with an acid solution and then oxidizing a surface of the unit with an acid solution.

It is another further object of the present invention to provide a method for treating a gas dispensing unit used in chemical vapor deposition that first cleans the unit with a diluted acid solution of HNO₃ and HF and then oxidizing a top surface of the unit with a solution of HNO₃ and HF.

It is still another object of the present invention to provide a method for treating a gas dispensing unit used in chemical vapor deposition by first cleaning the unit and then oxidizing a top surface of the unit for a sufficient length of time until an Al₂O₃ layer of at least 1 μm thickness is formed.

It is yet another object of the present invention to provide a method for treating a gas dispensing device used in chemical vapor deposition by first cleaning the device with a diluted acid solution containing about 10 vol. % HNO₃, about 10 vol. % HF and about 80 vol. % deionized water.

It is still another further object of the present invention to provide a gas dispensing device for use in chemical vapor deposition which includes a circular body that has a planar surface and a mixing chamber in the body wherein the planar surface is formed a thin layer of Al₂O₃ on top.

It is yet another further object of the present invention to provide a gas dispensing device for use in chemical vapor deposition wherein the device has a layer of Al₂O₃ formed on top with a thickness between about 1 μm and about 100 μm.

### SUMMARY OF THE INVENTION

In accordance with the present invention, a method for treating a gas dispensing device used in chemical vapor deposition and a device treated by such method are disclosed.

In a preferred embodiment, a method for treating a gas dispensing device used in chemical vapor deposition can be carried out by the operating steps of providing a gas dispensing device fabricated substantially of aluminum that has a planar surface with a multiplicity of apertures; exposing the planar surface to a diluted acid solution including HNO₃; removing residual diluted acid solution from the planar surface; and exposing the planar surface to an acid including HNO₃ for a sufficient length of time until an Al₂O₃ layer of at least 1 μm thickness is formed on the planar surface.

The method for treating a gas dispensing device used in chemical vapor deposition may further include the step of providing the gas dispensing device equipped with a gas mixing chamber and a multiplicity of apertures, or the step of exposing the planar surface to a dilute acid solution that includes HNO₃ and HF, or the step of exposing the planar surface to a diluted acid solution that includes between about 5 vol. % and about 25 vol. % HNO₃ and between about 0 vol. % and about 15 vol. % HF, or the step of exposing the planar surface to a diluted acid solution that includes between about 10 vol. % HNO₃, about 10 vol. % HF and about 80 vol. % deionized water. The method may further include the step of exposing the planar surface to a diluted acid solution that includes HNO₃ at a temperature between about 7° C. and about 27° C., or the step of exposing the planar surface to a diluted acid solution that includes HNO₃ at a temperature that is substantially an ambient temperature.

The method for treating a gas dispensing device used in chemical vapor deposition may further include the step of removing the residual diluted acid solution from the planar surface by rinsing with deionized water, or the step of removing the residual diluted acid solution from the planar surface by a degreasing step and a polishing step. The method may further include the step of exposing the planar surface to an acid solution including HNO₃ and HF, or the step of exposing the planar surface to an acid solution including HNO₃ and HF at a mixing ratio between about 1:1 and about 1:3. The method may further include the step of exposing the planar surface to an acid solution that includes HNO₃ and HF with HNO₃ being the major component. The method may further include the step of exposing the planar surface to an acid that includes HNO₃ at a temperature between about 30° C. and about 50° C. The method may further include the step of exposing the planar surface to an acid solution that includes HNO₃ for a sufficient length of time until an Al₂O₃ layer that has a thickness of between about 1 μm and about 100 μm is formed on the planar surface.

The present invention is further directed to a gas dispensing device for use in chemical vapor deposition that includes a circular body that has a planar surface and a mixing chamber in the body, the planar surface is formed of aluminum that has a multiplicity of apertures therethrough in fluid communication with the mixing chamber; and a top layer on the planar surface formed of Al₂O₃ that has a thickness of at least 1 μm.

In the gas dispensing device for use in chemical vapor deposition, the top layer on the planar surface that is formed of Al₂O₃ may have a thickness of between about 1 μm and about 100 μm, or the top layer may be formed of Al₂O₃ that has a thickness between about 10 μm and about 30 μm. The circular body may further include a surface opposite to the planar surface equipped with at least one reactant gas inlet.

### BRIEF DESCRIPTION OF THE DRAWINGS

These and other objects, features and advantages of the present invention will become apparent from the following detailed description and the appended drawings in which:

FIG. 1 is a cross-sectional view of a conventional chemical vapor deposition apparatus including a gas dispensing device and a susceptor for holding a wafer.

FIG. 2 is a perspective view of a conventional gas dispensing device, or a shower head.

FIG. 3 is a block diagram illustrating a process flow of the present invention method.

FIG. 4 is a plot of the thickness uniformity of a layer of silicon oxide deposited by a conventional gas dispensing device.

FIG. 5 is a graph illustrating a thickness uniformity of a silicon oxide layer deposited by using the present invention gas dispensing device.

FIG. 6 is a graph illustrating the total particle counts obtained from a conventional gas dispensing device and from a present invention gas dispensing device.

FIG. 7 is a graph illustrating large particle counts obtained from a conventional gas dispensing device and from a present invention gas dispensing device.

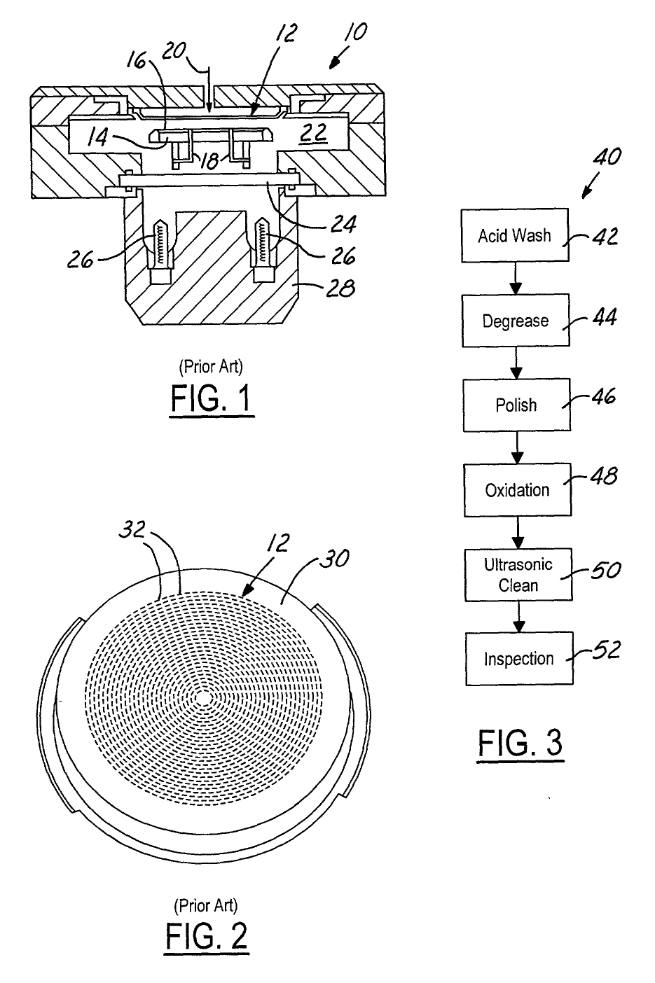

### DETAILED DESCRIPTION OF THE PREFERRED EMBODIMENT

The present invention discloses a method for treating a gas dispensing device used in chemical vapor deposition and the device treated by such method.

The present invention novel method, a gas dispensing device is treated in a dual-step treatment method in which the device is first washed by an acid solution that contains at least HNO₃, and then oxidized by an acid that contains at least HNO₃ for a length of time sufficient to grow an Al₂O₃ layer of at least 1 μm thickness on a top surface of the device. The wash solution of the diluted acid may include HNO₃ and HF diluted in deionized water, or may include between about 5 vol. % and about 25 vol. % HNO₃ and between about 0 vol. % and about 15 vol. % HF. In one suitable solution utilized in the preferred embodiment, the cleaning solution includes about 10 vol. % HNO₃, about 10 vol. % HF and about 80 vol. % deionized water. The word “about” used in this writing indicates a range of values that are ±10% from the average value given.

In the dual-step cleaning/oxidation process, the oxidation step is carried out by using an acid solution that consists of at least HNO₃, and preferably HNO₃ and HF at a mix ratio between about 1:1 and about 1:3. The oxidation process is preferably conducted in the acid solution that is maintained at a temperature between about 30° C. and about 50° C., a suitable temperature used in the preferred embodiment is about 40° C. The planar surface of the gas dispensing device is exposed to the oxidation acid solution for a sufficient length of time such that a thickness of at least 1 μm of Al₂O₃ is formed on the planar surface, or a thickness of between about 1 μm and about 100 μm is formed on the planar surface, preferably a thickness between about 10 μm and about 30 μm of Al₂O₃ is formed.

The present invention dual-step treatment method for a gas dispensing device can be used to resolve both the local particle problem and the thickness uniformity problem which leads to a more frequent than normal preventative maintenance procedure of the gas dispensing device, or the shower head. The present invention unique dual-step cleaning/oxidation treatment method is used to clean a shower head surface and then forms an oxidation layer of Al₂O₃ on a top surface of the shower head. In the first step, a diluted acid solution at a specific concentration of an acid that contains at least HNO₃, and preferably HNO₃ and HF diluted by deionized water is used. In a specific example of the present invention, the method is used to clean and treat a shower head utilized in a Applied Material Centura™ chamber that was used in a sub-atmospheric undoped silicate glass deposition process.

In the second step of the present invention novel method, an acid solution of HNO₃ and HF are mixed at a specific mix ratio and maintained at a temperature slightly higher than ambient temperature is used to oxidize the shower head material, i.e. aluminum, forming Al₂O₃ in a surface oxidization process resulting in a densely packed oxide layer. The oxide layer, acts as a barrier layer, was used effectively to provide protection for the gas dispensing device from attacks by plasma ions of fluorine during a preventive maintenance procedure.

In the first cleaning step, a suitable diluted acid solution that includes HNO₃ and HF may be used which may have a composition range between about 5 vol. % and about 25 vol. % HNO₃ and between about 0 vol. % and about 15 vol. % HF. In a specific example utilized in the present invention preferred embodiment, a diluted acid solution for cleaning the top surface of the gas dispensing device is formed with about 10 vol. % HNO₃, about 10 vol. % HF and about 80 vol. % deionized water. The diluted acid solution is kept at a temperature between about 17° C. and about 27° C. during the cleaning process when exposed to the gas dispensing device, or can be kept at a temperature that is substantially ambient temperature.

In-between the cleaning step and the oxidation step, the residual diluted acid solution on the surface of the gas dispensing device must be removed by either a rinsing step with deionized water, or by a degreasing step and followed by a polishing step.

In the second step of the present invention novel dual-step treatment process of a gas dispensing device, an acid solution that contains at least HNO₃, and preferably HNO₃ and HF at a mixed ration of between about 1:1 and about 1:3 is utilized. In the acid solution, the HNO₃ component is usually the major component. The acid solution is kept at a temperature between about 30° C. and about 50° C. when exposed to the surface of the gas dispensing device during the oxidation process. A suitable temperature used in the preferred embodiment for oxidizing an aluminum surface is about 40° C.

During the oxidization step, the surface of the gas dispensing device is exposed to the acid solution kept at a higher than ambient temperature for a length of time that is sufficient to form a metal oxide layer, i.e. Al₂O₃, that has a thickness of at least 1 μm, or to a thickness between about 1 μm and about 100 μm, or preferably to a thickness between about 10 μm and about 30 μm.

The present invention novel method is illustrated in a block diagram process flowchart 40 in FIG. 3. In the process flow, a gas dispensing device is first inspected and then acid washed in step 42 by a diluted acid solution that contains at least HNO₃, and preferably contains both HNO₃ and HF at a concentration between about 5 vol. % and about 25 vol. % HNO₃ and between about 0 vol. % and about 15 vol. % HF, with the balance being deionized water. After the acid washing step 42, a rinsing step or a degreasing step 44 which is followed by a mechanical polishing step 46 can be used to remove all residual diluted acid solution from the surface of the gas dispensing device. After the residual diluted acid solution is completely removed from the surface of the acid dispensing device, an oxidation step 48 is carried out as described previously by using the acid solution that contains at least HNO₃, and preferably HNO₃ and HF at a mix ratio between about 1:1 and about 1:3. The oxidation process is preferably conducted in the acid solution that is kept at a temperature higher than ambient temperature, i.e. at a temperature between about 30° C. and about 50° C. After the completion of the oxidation step 48, an ultrasonic cleaning step 50 is carried out to remove all residual acid solution from the surface of the gas dispensing device. A final inspection step 52 is then carried out to ensure quality control of the surface and the multiplicity of apertures.

The present invention novel method solves a local particle problem which would otherwise lead to a more frequent chamber wet cleaning than that required by the preventative maintenance schedule. The method slows down the thickness uniformity trend-up speed from about 1300 pieces to about 2200 pieces and thus, extending the chamber preventive maintenance lifetime. The present invention novel method further reduces the preventive maintenance failure rate and thus increasing the tool-up time.

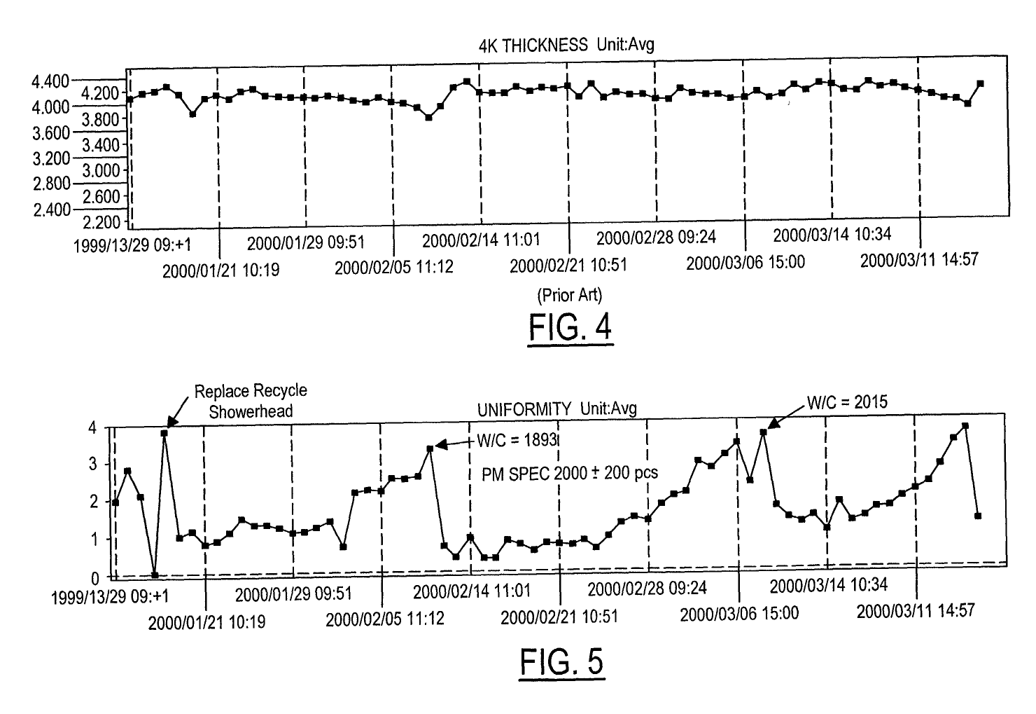

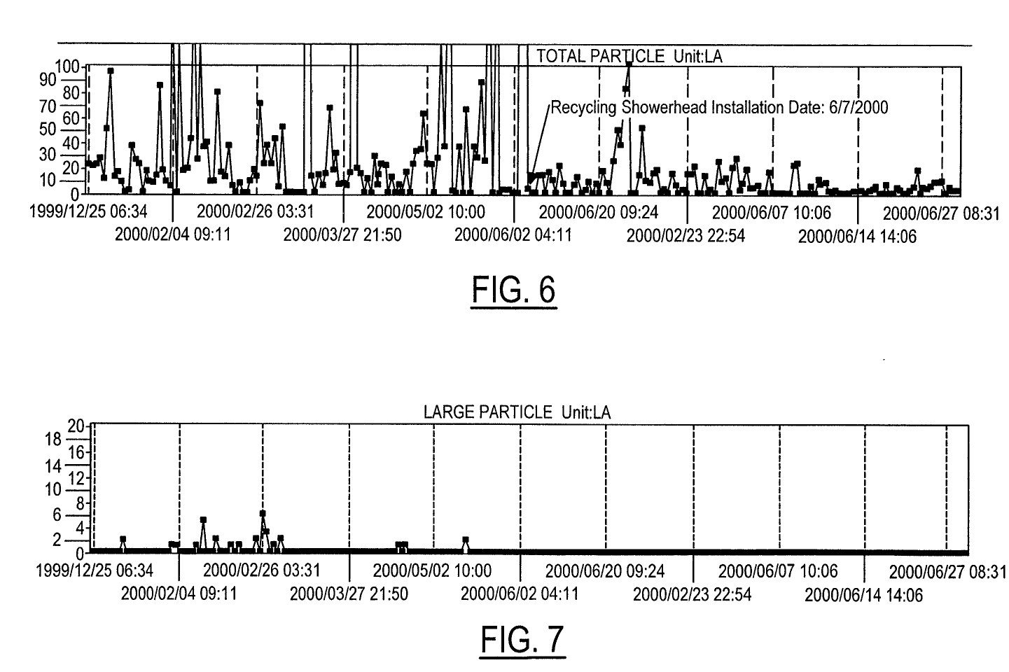

The effectiveness of the present invention novel method can be seen in FIGS. 5, 6 and 7. As shown in FIG. 5, the thickness uniformity of the film deposition from the gas dispensing device is substantially improved from that shown in FIG. 4. Furthermore, the total particle counts (FIG. 6) and the large particle counts (FIG. 7) after the implementation of the present invention novel method clearly indicates that a drastic reduction in the particle counts in both cases was achieved.

The present invention novel method for treating a gas dispensing device, i.e. a shower head, and the device treated have therefore been amply described in the above description and in the appended drawings of FIGS. 3, 5, 6 and 7.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A method for treating a gas dispensing device used in chemical vapor deposition comprising the steps of:
providing a gas dispensing device fabricated substantially of aluminum having a planar surface with a multiplicity of apertures;
exposing said planar surface to a diluted acid solution comprising HNO₃;
removing residual diluted acid solution from said planar surface; and
exposing said planar surface to an acid solution comprising HNO₃ for a sufficient length of time until an Al₂O₃ layer of at least 1 μm thickness is formed on said planar surface.

2. A method for treating a gas dispensing device used in chemical vapor deposition according to claim 1 further comprising the step of providing said gas dispensing device equipped with a gas mixing chamber and a multiplicity of apertures.

3. A method for treating a gas dispensing device used in chemical vapor deposition according to claim 1 further comprising the step of exposing said planar surface to a diluted acid solution comprising HNO₃ and HF.

4. A method for treating a gas dispensing device used in chemical vapor deposition according to claim 1 further comprising the step of exposing said planar surface to a diluted acid solution comprising between about 5 vol. % and about 25 vol. % HNO₃ and between about 0 vol. % and about 15 vol. % HF.

5. A method for treating a gas dispensing device used in chemical vapor deposition according to claim 1 further comprising the step of exposing said planar surface to a diluted acid solution comprising about 10 vol. % HNO₃, about 10 vol. % HF and about 80 vol. % deionized water.

6. A method for treating a gas dispensing device used in chemical vapor deposition according to claim 1 further comprising the step of exposing said planar surface to a diluted acid solution comprising HNO₃ at a temperature between about 17° C. and about 27° C.

7. A method for treating a gas dispensing device used in chemical vapor deposition according to claim 1 further comprising the step of exposing said planar surface to a diluted acid solution comprising HNO₃ at a temperature that is substantially an ambient temperature.

8. A method for treating a gas dispensing device used in chemical vapor deposition according to claim 1 further comprising the step of removing the residual diluted acid solution from said planar surface by rinsing with deionized water.

9. A method for treating a gas dispensing device used in chemical vapor deposition according to claim 1 further comprising the step of removing the residual diluted acid solution from said planar surface by a degreasing step and a polishing step.

10. A method for treating a gas dispensing device used in chemical vapor deposition according to claim 1 further comprising the step of exposing said planar surface to an acid solution comprising HNO₃ and HF.

11. A method for treating a gas dispensing device used in chemical vapor deposition according to claim 1 further comprising the step of exposing said planar surface to an acid solution comprising HNO₃ and HF at a mixing ratio between about 1:1 and about 1:3.

12. A method for treating a gas dispensing device used in chemical vapor deposition according to claim 1 further comprising the step of exposing said planar surface to an acid solution comprising HNO₃ and HF with HNO₃ being the major component.

13. A method for treating a gas dispensing device used in chemical vapor deposition according to claim 1 further comprising the step of exposing said planar surface to an acid solution comprising HNO₃ at a temperature between about 30° C. and about 50° C.

14. A method for treating a gas dispensing device used in chemical vapor deposition according to claim 1 further comprising the step of exposing said planar surface to an acid solution comprising HNO₃ for a sufficient length of time until an Al₂O₃ layer having a thickness between about 1 μm and about 100 μm is formed on said planar surface.

15. A gas dispensing device for use in chemical vapor deposition comprising:
a circular body having a planar surface and a mixing chamber in said body, said planar surface being formed of aluminum having a multiplicity of apertures therethrough in fluid communication with said mixing chamber; and
a top layer on said planar surface formed of Al₂O₃ having a thickness of at least 1 μm.

16. A gas dispensing device for use in chemical vapor deposition according to claim 15, wherein said top layer on said planar surface being formed of Al₂O₃ having a thickness between about 1 μm and about 100 μm.

17. A gas dispensing device for use in chemical vapor deposition according to claim 15, wherein said top layer on said planar surface being formed of Al₂O₃ having a thickness between about 10 μm and about 30 μm.

18. A gas dispensing device for use in chemical vapor deposition according to claim 15, wherein said circular body further comprises a surface opposite to said planar surface equipped with at least one reactant gas inlet.
